(19) United States
(12) Patent Application Publication
(10) Pub. No.: US 2026/0178445 A1
(43) Pub. Date: Jun. 25, 2026

(54) ENCODING CONTROL METHOD, MEMORY STORAGE DEVICE, AND MEMORY CONTROL CIRCUIT UNIT

(71) Applicant: PHISON ELECTRONICS CORP., Miaoli (TW)

(72) Inventors: Yu-Hsiang Lin, Yunlin County (TW); Bo Lun Huang, Tainan City (TW)

(73) Assignee: PHISON ELECTRONICS CORP., Miaoli (TW)

(21) Appl. No.: 19/059,273

(22) Filed: Feb. 21, 2025

(30) Foreign Application Priority Data
Dec. 19, 2024 (TW) 113149680

(51) Int. Cl. G06F 11/10; G06F 13/16

(52) U.S. Cl. CPC G06F 11/1068; G06F 11/1004; G06F 13/1668

(57) ABSTRACT

An encoding control method, a memory storage device, and a memory control circuit unit are provided. The encoding control method includes: obtaining write data; performing an encoding operation by an encoding circuit to generate first parity data and second parity data according to the write data, in which the second parity data is not generated according to the first parity data; sending a first write command sequence to instruct a storage of the write data, the first parity data, and the second parity data in a rewritable non-volatile memory module, in which the first parity data is used to perform a decoding operation with the write data, and the second parity data, along with the first parity data, is used to perform the decoding operation with the write data.

### CROSS-REFERENCE TO RELATED APPLICATION

This application claims the priority benefit of Taiwan application serial no. 113149680, filed on Dec. 19, 2024. The entirety of the above-mentioned patent application is hereby incorporated by reference herein and made a part of this specification.

### BACKGROUND

### 1. Technology Field

The disclosure relates to an encoding control technology, and more particularly, to an encoding control method, a memory storage device, and a memory control circuit unit.

### 2. Description of Related Art

The growth of portable electronic devices such as mobile phones and laptops has been extremely rapid in recent years, leading to a sharp increase in consumer demand for storage media. Due to the characteristics of rewritable non-volatile memory modules (e.g., flash memories) including data non-volatility, power efficiency, small volume, and lack of mechanical structures, the rewritable non-volatile memory modules are highly suitable for integration into various portable electronic devices as those mentioned above.

In general, to maintain data reliability, data is encoded to generate a corresponding error correcting code before the data is stored in a rewritable non-volatile memory module. The error correcting code is then stored in the rewritable non-volatile memory module along with the corresponding data. Later, when the data is read out from the rewritable non-volatile memory module, the corresponding error correcting code can be used to correct possible errors in the data. However, the data length of the normal error correcting code is not dynamically adjustable and is inflexible in use. In addition, to improve error correction capability, data is first encoded to generate a corresponding error correction code, and the data and the error correction code are further encoded to generate another error correction code. Such an encoding method may cause latency issues, thereby affecting the performance of the rewritable non-volatile memory module.

### SUMMARY

The disclosure provides an encoding control method, a memory storage device, and a memory control circuit unit capable of generating parity data with different data lengths through parallel encoding, so as to improve the error correction capability without causing any latency issue.

Exemplary embodiments of the disclosure provide an encoding control method for a rewritable non-volatile memory module. The encoding control method includes: obtaining write data; performing an encoding operation by an encoding circuit according to the write data to generate first parity data and second parity data, wherein the second parity data is not generated according to the first parity data; sending a first write command sequence to instruct a storage of the write data, the first parity data, and the second parity data in the rewritable non-volatile memory module, wherein the first parity data is used to perform a decoding operation with the write data, and the second parity data, along with the first parity data, is used to perform the decoding operation with the write data.

In an exemplary embodiment of the disclosure, the encoding operation includes a first encoding operation and a second encoding operation, wherein the step of performing the encoding operation by the encoding circuit according to the write data to generate the first parity data and the second parity data includes: performing the first encoding operation by a first encoding circuit in the encoding circuit according to the write data to generate the first parity data; performing the second encoding operation by a second encoding circuit in the encoding circuit according to the write data to generate the second parity data, wherein the first encoding operation and the second encoding operation are performed simultaneously.

In an exemplary embodiment of the disclosure, the encoding control method further includes: performing a third encoding operation by a third encoding circuit in the encoding circuit according to the write data to generate third parity data, wherein the third parity data is not generated according to the first parity data and the second parity data; sending a second write command sequence to instruct a storage of the third parity data in the rewritable non-volatile memory module, wherein the third parity data, along with the first parity data and the second parity data, is used to perform the decoding operation with the write data, and the first encoding operation, the second encoding operation, and the third encoding operation are performed simultaneously.

Exemplary embodiments of the disclosure further provide an encoding control method for a rewritable non-volatile memory module. The encoding control method includes following steps: obtaining write data; performing a first encoding operation by an encoding circuit to generate first parity data according to the write data, a first sub-matrix of a parity check matrix, and a second sub-matrix of the parity check matrix; performing a second encoding operation by the encoding circuit to generate second parity data according to the write data, a third sub-matrix of the parity check matrix, and a fourth sub-matrix of the parity check matrix; sending a first write command sequence to instruct a storage of the write data, the first parity data, and the second parity data in a rewritable non-volatile memory module, wherein the first encoding operation and the second encoding operation are performed simultaneously.

In an exemplary embodiment of the disclosure, the first encoding operation includes: generating first transient data by the encoding circuit according to the write data and the first sub-matrix; generating the first parity data by the encoding circuit according to the first transient data and the second sub-matrix.

In an exemplary embodiment of the disclosure, the second encoding operation includes: generating second transient data by the encoding circuit according to the write data and the third sub-matrix; generating the second parity data by the encoding circuit according to the second transient data and the fourth sub-matrix.

In an exemplary embodiment of the disclosure, the encoding control method further includes: performing a third encoding operation by the encoding circuit according to the write data, a fifth sub-matrix in the parity check matrix, and a sixth sub-matrix in the parity check matrix to generate third parity data; sending a second write command sequence to instruct a storage of the third parity data in the rewritable non-volatile memory module, wherein the first encoding operation, the second encoding operation, and the third encoding operation are performed at the same time

In an exemplary embodiment of the disclosure, the third encoding operation includes: generating third transient data by the encoding circuit according to the write data and the fifth sub-matrix; generating the third parity data by the encoding circuit according to the third transient data and the sixth sub-matrix.

Exemplary embodiments of the disclosure further provide a memory storage device, which includes a connection interface unit, a rewritable non-volatile memory module, and a memory control circuit unit. The connection interface unit is coupled to a host system. The memory control circuit unit is coupled to the connection interface unit and the rewritable non-volatile memory module. The memory control circuit unit is configured to obtain write data. The memory control circuit unit is further configured to send a first write command sequence to instruct a storage of the write data, first parity data, and second parity data in the rewritable non-volatile memory module. The memory control circuit unit includes an encoding circuit. The encoding circuit is configured to perform an encoding operation to generate the first parity data and the second parity data according to the write data, wherein the second parity data is not generated according to the first parity data. The first parity data is used to perform a decoding operation with the write data, and the second parity data, along with the first parity data, is used to perform the decoding operation with the write data.

In an exemplary embodiment of the disclosure, the encoding circuit includes a first encoding circuit and a second encoding circuit, and the encoding operation includes a first encoding operation and a second encoding operation. The first encoding circuit performs the first encoding operation according to the write data to generate the first parity data. The second encoding circuit performs the second encoding operation according to the write data to generate the second parity data. The first encoding operation and the second encoding operation are performed simultaneously.

In an exemplary embodiment of the disclosure, the encoding circuit includes a third encoding circuit. The third encoding circuit performs a third encoding operation according to the write data to generate third parity data, wherein the third parity data is not generated according to the first parity data and the second parity data. The memory control circuit unit sends a second write command sequence to instruct a storage of the third parity data in the rewritable non-volatile memory module. The third parity data, along with the first parity data and the second parity data, is used to perform the decoding operation with the write data. The first encoding operation, the second encoding operation, and the third encoding operation are performed simultaneously.

Exemplary embodiments of the disclosure further provide a memory storage device, which includes a connection interface unit, a rewritable non-volatile memory module, and a memory control circuit unit. The connection interface unit is coupled to a host system. The memory control circuit unit is coupled to the connection interface unit and the rewritable non-volatile memory module. The memory control circuit unit is configured to obtain write data. The memory control circuit unit is further configured to send a first write command sequence to instruct a storage of the write data, first parity data, and second parity data in the rewritable non-volatile memory module. The memory control circuit unit includes an encoding circuit. The encoding circuit is configured to perform a first encoding operation according to the write data, a first sub-matrix in a parity check matrix, and a second sub-matrix in the parity check matrix to generate the first parity data. The encoding circuit is further configured to perform a second encoding operation according to the write data, a third sub-matrix in the parity check matrix, and a fourth sub-matrix in the parity check matrix to generate the second parity data, wherein the first encoding operation and the second encoding operation are performed simultaneously.

In an exemplary embodiment of the disclosure, the encoding circuit includes a first encoding circuit and a second encoding circuit.

In an exemplary embodiment of the disclosure, in the first encoding operation, the first encoding circuit generates first transient data according to the write data and the first sub-matrix and generates the first parity data according to the first transient data and the second sub-matrix.

In an exemplary embodiment of the disclosure, in the second encoding operation, the second encoding circuit generates second transient data according to the write data and the third sub-matrix and generates the second parity data according to the second transient data and the fourth sub-matrix.

In an exemplary embodiment of the disclosure, the encoding circuit performs a third encoding operation according to the write data, a fifth sub-matrix in the parity check matrix, and a sixth sub-matrix in the parity check matrix to generate third parity data. The memory control circuit unit sends a second write command sequence to instruct a storage of the third parity data in the rewritable non-volatile memory module. The first encoding operation, the second encoding operation, and the third encoding operation are performed simultaneously

In an exemplary embodiment of the disclosure, the encoding circuit includes a third encoding circuit. In the third encoding operation, the third encoding circuit generates third transient data according to the write data and the fifth sub-matrix and generates the third parity data according to the third transient data and the sixth sub-matrix

Exemplary embodiments of the disclosure further provide a memory control circuit unit for controlling a rewritable non-volatile memory module. The memory control circuit unit includes a host interface, a memory interface, an encoding circuit, and a memory management circuit. The host interface is coupled to the host system. The memory interface is coupled to the rewritable non-volatile memory module. The memory management circuit is coupled to the host interface, the memory interface, and the encoding circuit. The memory management circuit is configured to obtain write data. The memory control circuit unit is further configured to send a first write command sequence to instruct a storage of the write data, first parity data, and second parity data in the rewritable non-volatile memory module. The encoding circuit is configured to perform an encoding operation to generate the first parity data and the second parity data according to the write data, wherein the second parity data is not generated according to the first parity data. The first parity data, is used to perform a decoding operation with the write data, and the second parity data, along with the first parity data, is used to perform the decoding operation with the write data.

In an exemplary embodiment of the disclosure, the encoding circuit includes a third encoding circuit. The third encoding circuit performs a third encoding operation according to the write data to generate third parity data, wherein the third parity data is not generated according to the first parity data and the second parity data. The memory management circuit sends a second write command sequence to instruct a storage of the third parity data in the rewritable non-volatile memory module. The third parity data, along with the first parity data and the second parity data, is used to perform the decoding operation with the write data. The first encoding operation, the second encoding operation, and the third encoding operation are performed simultaneously.

Exemplary embodiments of the disclosure further provide a memory control circuit unit for controlling a rewritable non-volatile memory module. The memory control circuit unit includes a host interface, a memory interface, an encoding circuit, and a memory management circuit. The host interface is coupled to the host system. The memory interface is coupled to the rewritable non-volatile memory module. The memory management circuit is coupled to the host interface, the memory interface, and the encoding circuit. The memory management circuit is configured to obtain write data. The memory control circuit unit is further configured to send a first write command sequence to instruct a storage of the write data, first parity data, and second parity data in the rewritable non-volatile memory module. The encoding circuit is configured to perform a first encoding operation according to the write data, a first sub-matrix in a parity check matrix, and a second sub-matrix in the parity check matrix to generate the first parity data. The encoding circuit is further configured to perform a second encoding operation according to the write data, a third sub-matrix in the parity check matrix, and a fourth sub-matrix in the parity check matrix to generate the second parity data, wherein the first encoding operation and the second encoding operation are performed simultaneously.

In an exemplary embodiment of the disclosure, the encoding circuit performs a third encoding operation according to the write data, a fifth sub-matrix in the parity check matrix, and a sixth sub-matrix in the parity check matrix to generate third parity data. The memory management circuit sends a second write command sequence to instruct a storage of the third parity data in the rewritable non-volatile memory module. The first encoding operation, the second encoding operation, and the third encoding operation are performed simultaneously.

In view of the above, in the encoding control method, the memory storage device, and the memory control circuit unit provided in one or more embodiments of the disclosure, after obtaining the write data, the encoding circuit can generate the first parity data and the second parity data simultaneously, and according to different operating conditions, the first parity data can be used alone or along with the second parity data to perform the decoding operation with the write data. As such, the error correction capability can be improved without causing encoding delay.

It should be understood, however, that this Summary may not contain all of the aspects and embodiments of the present invention, is not meant to be limiting or restrictive in any manner, and that the present invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic block diagram of a memory storage device according to an exemplary embodiment of the disclosure.

FIG. 5 is a schematic block diagram of a memory control circuit unit according to an exemplary embodiment of the disclosure.

FIG. 6 is a schematic block diagram of managing a rewritable non-volatile memory module according to an exemplary embodiment of the disclosure.

FIG. 7 is a schematic diagram of a decoding process according to an exemplary embodiment of the disclosure.

FIG. 8 is a schematic diagram of a parity check matrix according to an exemplary embodiment of the disclosure.

FIG. 9 is a schematic diagram of a parity check matrix according to an exemplary embodiment of the disclosure.

FIG. 10 is a flowchart of an encoding control method according to an exemplary embodiment of the disclosure.

FIG. 11 is a flowchart of an encoding control method according to an exemplary embodiment of the disclosure.

### DESCRIPTION OF THE EMBODIMENTS

Reference will now be made in detail to the exemplary embodiments of the invention, examples of which are illustrated in the accompanying drawings. Wherever possible, the same reference numbers are used in the drawings and the description to refer to the same or like parts.

Embodiments of the invention may comprise any one or more of the novel features described herein, including in the detailed description, and/or shown in the drawings. As used herein, “at least one,” “one or more,” and “and/or” are open-ended expressions that are both conjunctive and disjunctive in operation. For instance, each of the expressions “at least on of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Note that the term “a” or “an” entity refers to one or more of that entity. As such, the terms “a” (or “an”), “one or more,” and “at least one” can be used interchangeably herein.

In general, a memory storage device (also referred to as a memory storage system) includes a rewritable non-volatile memory module and a controller (also referred to as a control circuit). The memory storage device may be used in conjunction with a host system such that the host system may write data into the memory storage device or read data from the memory storage device.

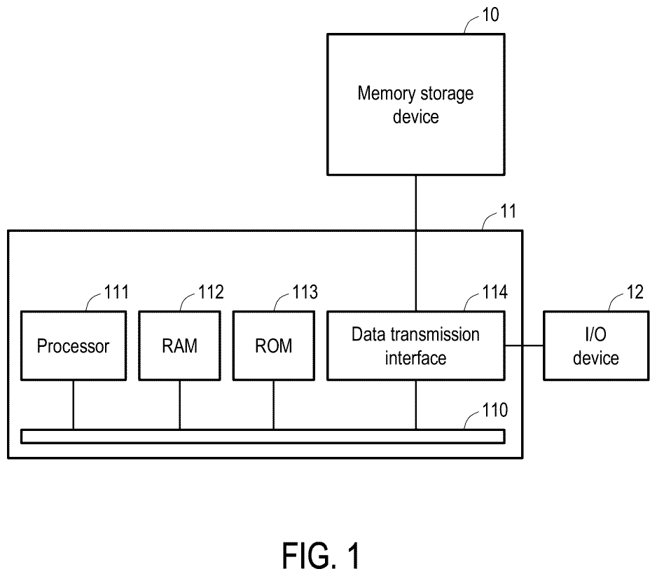

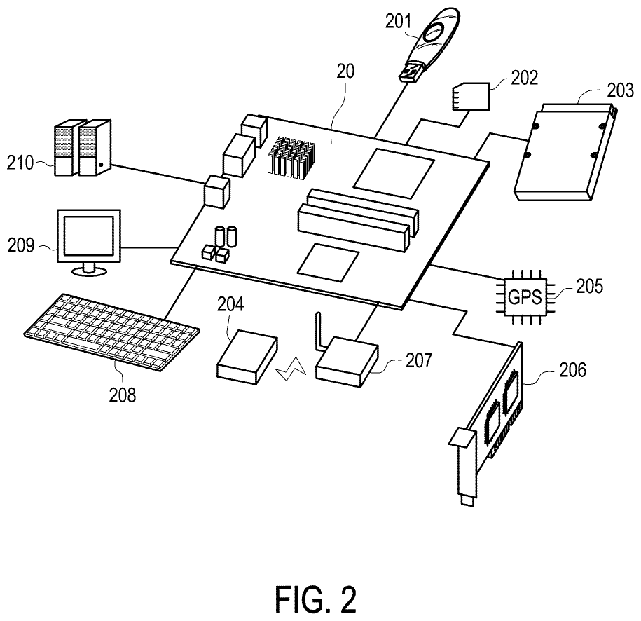

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

With reference to FIG. 1 and FIG. 2, a host system 11 may include a processor 111, a random access memory (RAM) 112, a read only memory (ROM) 113, and a data transmission interface 114. The processor 111, the random access memory 112, the ROM 113, and the data transmission interface 114 may be coupled to a system bus 110.

In an exemplary embodiment, the host system 11 may be coupled to a memory storage device 10 through the data transmission interface 114. For instance, the host system 11 may store data to the memory storage device 10 or read data from the memory storage device 10 through the data transmission interface 114. Moreover, the host system 11 may be coupled to an I/O device 12 through the system bus 110. For instance, the host system 11 may transmit output signals to the I/O device 12 or receive input signals from the I/O device 12 through the system bus 110.

In an exemplary embodiment, the processor 111, the random access memory 112, the ROM 113, and the data transmission interface 114 may be configured on a motherboard 20 of the host system 11. The number of the data transmission interfaces 114 may be one or more. Through the data transmission interface 114, the motherboard 20 may be coupled to the memory storage device 10 through wired or wireless means.

In an exemplary embodiment, the memory storage device 10 may be, for instance, a flash drive 201, a memory card 202, a solid state drive (SSD) 203, or a wireless memory storage device 204. The wireless memory storage device 204 may be, for instance, a memory storage device based on various wireless communication technologies, such as a near field communication (NFC) memory storage device, a WiFi memory storage device, a Bluetooth memory storage device, or a Bluetooth low energy memory storage device (e.g., iBeacon). In addition, the motherboard 20 may also be coupled to various I/O devices such as a global positioning system (GPS) module 205, a network interface card 206, a wireless transmission device 207, a keyboard 208, a screen 209, a speaker 210, and the like through the system bus 110. For instance, in an exemplary embodiment, the motherboard 20 may access the wireless memory storage device 204 through the wireless transmission device 207.

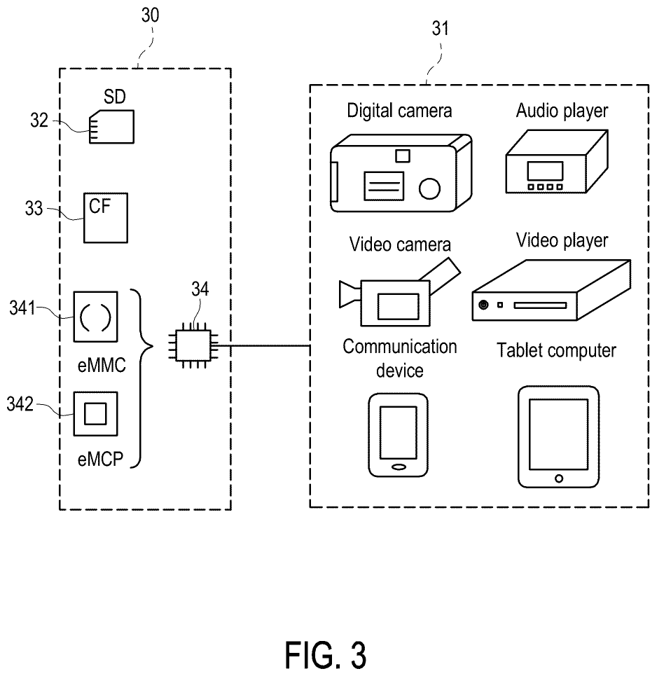

In an exemplary embodiment, the host system 11 is a computer system. In an exemplary embodiment, the host system 11 may be any system that may physically work with a memory storage device to store data. In an exemplary embodiment, the memory storage device 10 and the host system 11 may include a memory storage device 30 and a host system 31 of FIG. 3, respectively.

FIG. 3 is a schematic diagram of a host system and a memory storage device according to an exemplary embodiment of the disclosure. Referring to FIG. 3, the memory storage device 30 may be used in conjunction with the host system 31 to store data. For instance, the host system 31 may be a system such as a digital camera, a video camera, a communication device, an audio player, a video player, or a tablet computer. For instance, the memory storage device 30 may be various non-volatile memory storage devices such as a secure digital (SD) card 32, a compact flash (CF) card 33, or an embedded storage device 34 used by the host system 31. The embedded storage device 34 includes various types of embedded storage devices such as an embedded multimedia card (eMMC) 341 and/or an embedded multichip package (eMCP) storage device 342, which directly couples the memory modules to the substrate of the host system.

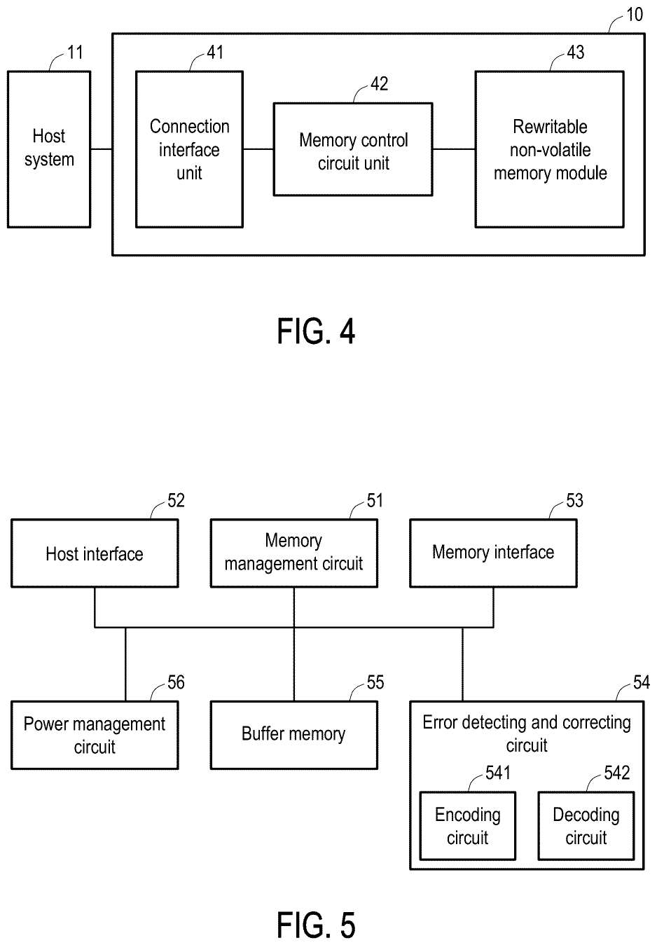

FIG. 4 is a schematic diagram of a memory storage device according to an exemplary embodiment of the disclosure. Referring to FIG. 4, the memory storage device 10 includes a connection interface unit 41, a memory control circuit unit 42, and a rewritable non-volatile memory module 43.

The connection interface unit 41 is configured to be coupled to the host system 11. The memory storage device 10 may communicate with the host system 11 through the connection interface unit 41. In an exemplary embodiment, the connection interface unit 41 is compatible with the peripheral component interconnect express (PCI Express) standard. In an exemplary embodiment, the connection interface unit 41 may also conform to the serial advanced technology attachment (SATA) standard, the parallel advanced technology attachment (PATA) standard, the Institute of Electrical and Electronics Engineers (IEEE) 1394 standard, universal serial bus (USB) standard, SD interface standard, the ultra-high speed-I (UHS-I) interface standard, the ultra-high speed II (UHS-II) interface standard, the memory stick (MS) interface standard, the MCP interface standard, the MMC interface standard, the eMMC interface standard, the universal flash Storage (UFS) interface standard, the eMCP Interface standard, the CF interface standard, the integrated device electronics (IDE) standard, or other suitable standard. The connection interface unit 41 and the memory control circuit unit 42 may be packaged in one chip, or the connection interface unit 41 may be arranged outside a chip including the memory control circuit unit 42.

The memory control circuit unit 42 is coupled to the connection interface unit 41 and the rewritable non-volatile memory module 43. The memory control circuit unit 42 is configured to execute a plurality of logic gates or control commands implemented in the form of hardware or firmware and perform operations such as data writing, reading, and erasing in the rewritable non-volatile memory module 43 according to a command of the host system 11.

The rewritable non-volatile memory module 43 is configured to store the data written by the host system 11. The rewritable non-volatile memory module 43 may include a single-level cell (SLC) NAND-type flash memory module (i.e., a flash memory module that may store one bit in one memory cell), a multi-level cell (MLC) NAND-type flash memory module (i.e., a flash memory module that may store two bits in one memory cell), a triple-level cell (TLC) NAND-type flash memory module (i.e., a flash memory module that may store three bits in one memory cell), a quad-level cell (QLC) NAND-type flash memory module (i.e., a flash memory module that may store four bits in one memory cell), other flash memory modules, or other memory modules having the same characteristics.

Each memory cell in the rewritable non-volatile memory module 43 stores one or more bits by changing a voltage (also referred to as a threshold voltage hereinafter). To be specific, a charge trapping layer is present between a control gate and a channel of each memory cell. By applying a write voltage to the control gate, the number of electrons in the charge trapping layer may be changed, and thus the threshold voltage of the memory cell may be changed. This operation of changing the threshold voltage of the memory cell is also referred to as “writing data into the memory cell” or “programming the memory cell”. As the threshold voltage changes, each memory cell in the rewritable non-volatile memory module 43 has a plurality of storage states. By applying a read voltage, it is possible to determine which storage state a memory cell belongs to, and thereby obtains one or more bits stored in the memory cell.

In an exemplary embodiment, the memory cells of the rewritable non-volatile memory module 43 may constitute a plurality of physical programming units, and these physical programming units may constitute a plurality of physical erasing units. To be specific, memory cells on the same word line may constitute one or more physical programming units. If each memory cell may store more than 2 bits, the physical programming unit on the same word line may be classified into at least a lower physical programming unit and an upper physical programming unit. For instance, a least significant bit (LSB) of a memory cell belongs to the lower physical programming unit, and a most significant bit (MSB) of a memory cell belongs to the upper physical programming unit. In general, in MLC NAND flash memory, the writing speed of the lower physical programming unit is higher than the writing speed of the upper physical programming unit, and/or the reliability of the lower physical programming unit is higher than the reliability of the upper physical programming unit.

In an exemplary embodiment, the physical programming unit is a minimum unit for programming. That is, the physical programming unit is the minimum unit for writing data. For instance, the physical programming unit may be a physical page or a physical sector. If the physical programming unit is the physical page, the physical programming units may include a data bit area and a redundancy bits area. The data bit area has multiple of physical sectors for storing user data, and the redundancy bits area is configured to store system data (e.g., management data such as an error correcting code). In an exemplary embodiment, the data bit area contains 32 physical sectors, and the size of each physical sector is 512 bytes (B). However, in other exemplary embodiments, the data bit area may also include 8, 16, or more or less physical sectors, and the size of each physical sector may also be larger or smaller. On the other hand, the physical erasing unit is the minimum unit for erasing. Namely, each physical erasing unit contains the least number of memory cells to be erased together. For instance, the physical erasing unit is a physical block.

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is configured to control the overall operation of the memory control circuit unit 42. To be specific, the memory management circuit 51 has a plurality of control commands, and when the memory storage device 10 operates, these control commands are executed to perform operations such as data writing, reading, and erasing. The following description of the operation of the memory management circuit 51 is equivalent to the description of the operation of the memory control circuit unit 42.

In an exemplary embodiment, the control commands of the memory management circuit 51 are implemented in the form of firmware. For instance, the memory management circuit 51 has a microprocessor unit (not shown) and a ROM (not shown), and these control commands are programmed into the ROM. When the memory storage device 10 operates, the control commands are executed by the microprocessor unit to perform operations such as data writing, reading and erasing.

In an exemplary embodiment, the control commands of the memory management circuit 51 may also be stored in a specific area (e.g., a system area dedicated to storing system data in the memory module) of the rewritable non-volatile memory module 43 in the form of code. Further, the memory management circuit 51 has a microprocessor unit (not shown), a read-only memory (not shown), and a random access memory (not shown). In particular, the ROM has a boot code, and when the memory control circuit unit 42 is enabled, the microprocessor unit will first execute the boot code to load the control command stored in the rewritable non-volatile memory module 43 into the random access memory of the memory management circuit 51. Subsequently, the microprocessor unit will run these control commands to perform operations such as data writing, reading and erasing.

In an exemplary embodiment, the control commands of the memory management circuit 51 may also be implemented in the form of a hardware. For instance, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit and the data processing circuit are coupled to the microcontroller. The memory cell management circuit is configured to manage the memory cells or memory cell groups of the rewritable non-volatile memory module 43. The memory writing circuit is configured to give a write command sequence to the rewritable non-volatile memory module 43 to write data into the rewritable non-volatile memory module 43. The memory reading circuit is configured to give a read command sequence to the rewritable non-volatile memory module 43 to read data from the rewritable non-volatile memory module 43. The memory erasing circuit is configured to give an erase command sequence to the rewritable non-volatile memory module 43 to erase data from the rewritable non-volatile memory module 43. The data processing circuit is configured to process both the data to be written into the rewritable non-volatile memory module 43 and the data to be read from the rewritable non-volatile memory module 43. The write command sequence, the read command sequence, and the erase command sequence may respectively include one or more program codes or command codes and are configured to instruct the rewritable non-volatile memory module 43 to perform corresponding operations of writing, reading, and erasing. In an exemplary embodiment, the memory management circuit 51 may also give other types of command sequences to the rewritable non-volatile memory module 43 and instruct the same to perform corresponding operations.

The host interface 52 is coupled to the memory management circuit 51. The memory management circuit 51 may communicate with the host system 11 through the host interface 52. The host interface 52 can be configured to obtain and identify the commands and data from the host system 11. For instance, the commands and data transmitted by the host system 11 may be transmitted to the memory management circuit 51 through the host interface 52. Further, the memory management circuit 51 may transmit data to the host system 11 through the host interface 52. In this exemplary embodiment, the host interface 52 is compliant with the PCI Express standard. However, it must be understood that the disclosure is not limited thereto. The host interface 52 may also be compatible with SATA standard, PATA standard, IEEE 1394 standard, USB standard, SD standard, UHS-I standard, UHS-II standard, MS standard, MMC standard, eMMC standard, UFS standard, CF standard, IDE standard or other suitable data transfer standard.

The memory interface 53 is coupled to the memory management circuit 51 and configured to access the rewritable non-volatile memory module 43. For instance, the memory management circuit 51 may access the rewritable non-volatile memory module 43 through the memory interface 53. That is, the data to be written into the rewritable non-volatile memory module 43 will be converted into a format acceptable to the rewritable non-volatile memory module 43 through the memory interface 53. To be specific, if the memory management circuit 51 tries to access the rewritable non-volatile memory module 43, the memory interface 53 will transmit corresponding command sequences. For example, these command sequences may include a write command sequence to instruct a writing of data, a read command sequence to instruct a reading of data, an erase command sequence to instruct to erase data, and corresponding command sequences to instruct various memory operations, such as changing voltage level, performing a garbage collection (GC) operation, and so on. These command sequences are, for example, generated by the memory management circuit 51 and transmitted to the rewritable non-volatile memory module 43 through the memory interface 53. These command sequences may include one or more signals, or data on the bus. These signals or data may include script or code. For example, in the read command sequence, information such as the read identification code and memory address will be included.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to perform error detecting and correcting operations to ensure the correctness of the data. To be specific, when the memory management circuit 51 obtains a write command from the host system 11, the error detecting and correcting circuit 54 generates corresponding error correcting code (ECC) and/or error detecting code (EDC) for the data corresponding to the write command, and the memory management circuit 51 writes the data corresponding to the write command and the corresponding error correcting code and/or error detecting code into the rewritable non-volatile memory module 43. Subsequently, when the memory management circuit 51 reads data from the rewritable non-volatile memory module 43, it simultaneously reads the error correcting code and/or error detecting code corresponding to the data, and the error detecting and correcting circuit 54 will perform error detecting and correcting operations on the read data according to the error correcting code and/or the error detecting code.

In an exemplary embodiment, the error detecting and correcting circuit 54 may support low-density parity check (LDPC) codes. For example, an error detecting and correcting circuit 54 may use low-density parity check codes for encoding and decoding. In an exemplary embodiment, the error detecting and correcting circuit 54 may also use other types of encoding/decoding algorithms, such as BCH or Reed-Solomon (RS) codes. The disclosure is not limited thereto.

The buffer memory 55 is coupled to the memory management circuit 51 and configured to temporarily store data. The power management circuit 56 is coupled to the memory management circuit 51 and configured to control the power of the memory storage device 10.

In an exemplary embodiment, the rewritable non-volatile memory module 43 of FIG. 4 may include a flash memory module. In an example embodiment, the memory control circuit unit 42 of FIG. 4 may include a flash memory controller. In an example embodiment, the memory management circuit 51 of FIG. 5 may include a flash memory management circuit.

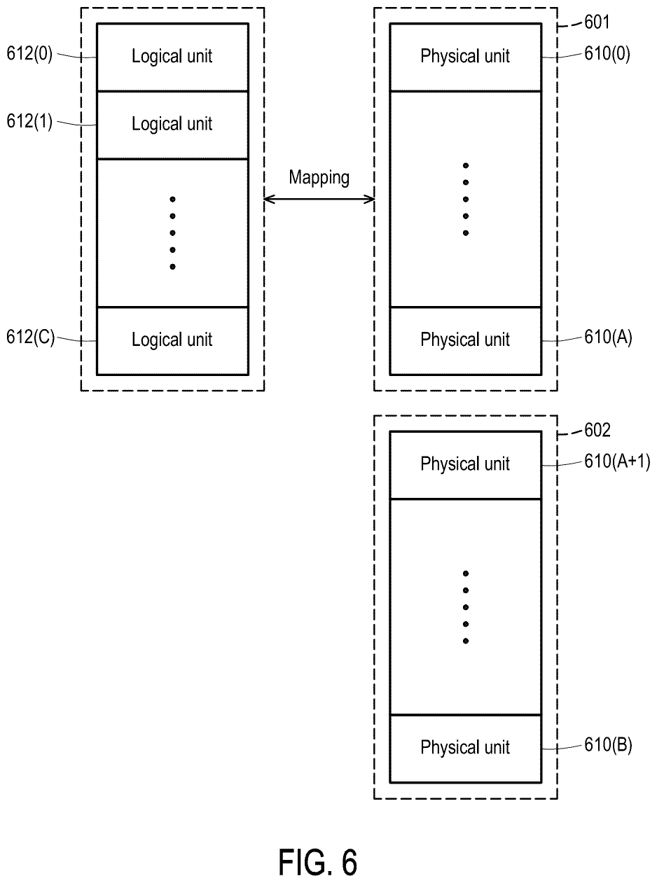

FIG. 6 is a schematic diagram of managing a rewritable non-volatile memory module according to an exemplary embodiment of the disclosure. Referring to FIG. 6, the memory management circuit 51 may logically group physical units 610(0) to 610(B) in the rewritable non-volatile memory module 43 into a storage area 601 and a spare area 602.

In an exemplary embodiment, a physical unit refers to a physical address or a physical programming unit. In an exemplary embodiment, a physical unit may also be composed of a plurality of consecutive or non-consecutive physical addresses. In an exemplary embodiment, a physical unit may also refer to a virtual block (VB). A virtual block may include a plurality of physical addresses or a plurality of physical programming units.

The physical units 610(0) to 610(A) in the storage area 601 are configured to store user data (e.g., user data from the host system 11 of FIG. 1). For example, the physical units 610(0) to 610(A) in the storage area 601 may store valid data and invalid data. The physical units 610(A+1) to 610(B) in the spare area 602 do not store data (e.g., valid data). For example, if a certain physical unit does not store valid data, this physical unit may be associated (or added) to the spare area 602. Moreover, the physical unit (or physical unit not storing valid data) in the spare area 602 may be erased. When new data is written, one or more physical units may be extracted from spare area 602 to store the new data. In an exemplary embodiment, the spare area 602 is also referred to as a free pool.

The memory management circuit 51 may configure logical units 612(0) to 612(C) to map the physical units 610(0) to 610(A) in the storage area 601. In an exemplary embodiment, each logical unit corresponds to a logical address. For example, a logical address may include one or more logical block addresses (LBA) or other logical management units. In an exemplary embodiment, a logical unit may also correspond to a logic programming unit or be composed of a plurality of consecutive or non-consecutive logical addresses.

Note that a logical unit may be mapped to one or more physical units. If a certain physical unit is currently mapped by a certain logical unit, it indicates that the data currently stored in this physical unit includes valid data. On the contrary, if a certain physical unit is not currently mapped by any logical unit, it indicates that the data currently stored in this physical unit is invalid data.

The memory management circuit 51 may record management data (also referred to as logical-to-physical mapping information) describing the mapping relationship between logical units and physical units in at least one logical-to-physical address mapping table. When the host system 11 tries to read data from the memory storage device 10 or write data into the memory storage device 10, the memory management circuit 51 may access the rewritable non-volatile memory module 43 according to the information in the logic-to-physical address mapping table.

In an exemplary embodiment, the error detecting and correcting circuit 54 can include an encoding circuit 541 and a decoding circuit 542. The encoding circuit 541 is configured to encode data. The decoding circuit 542 is configured to decode data. In an exemplary embodiment, the encoding circuit 541 and the decoding circuit 542 can also be combined into a single encoding/decoding circuit.

In an exemplary embodiment, before the memory management circuit 51 writes data into the rewritable non-volatile memory module 43, the data is first encoded to generate corresponding parity data, and the data and the parity data are then stored in the rewritable non-volatile memory module 43. The data that the memory management circuit 51 intends to write into the rewritable non-volatile memory module 43 (also referred to as write data) can be, for instance, data written by the host system 11 (user data) or management data of the memory management circuit 51. When the memory management circuit 51 intends to read a physical unit, the memory management circuit 51 can read the data in the physical unit and its corresponding parity data. The decoding circuit 542 in the error detecting and correcting circuit 54 can perform a decoding operation according to the parity data and the data read from the physical unit to detect and correct errors in the data.

In an exemplary embodiment, the memory management circuit 51 obtains the write data. The encoding circuit 541 can perform an encoding operation according to the write data to generate first parity data and second parity data. The encoding operation can include but is not limited to a first encoding operation and a second encoding operation. In an exemplary embodiment, the encoding circuit 541 can be, for instance, equipped with a first encoding circuit (not shown) and a second encoding circuit (not shown) that are independently operated. At the same time point, the first encoding circuit in the encoding circuit 541 can perform the first encoding operation according to the write data to generate the first parity data, and the second encoding circuit in the encoding circuit 541 can perform the second encoding operation according to the write data to generate the second parity data. In other words, the first encoding operation and the second encoding operation are performed simultaneously to reduce the delay caused by the encoding operation. The second parity data is not generated according to the first parity data. In an exemplary embodiment, the first parity data is different from the second parity data. Additionally, the first parity data can be used alone or along with the second parity data to perform the decoding operation with the write data. The second parity data needs to be used along with the first parity data to perform the decoding operation with the write data, meaning that the second parity data cannot be used alone to perform the decoding operation with the write data.

After encoding the write data, the memory management circuit 51 can send a write command sequence (also referred to as a first write command sequence) to the rewritable non-volatile memory module 43. The first write command sequence can be used to instruct the rewritable non-volatile memory module 43 to store the write data, the first parity data, and the second parity data. In an exemplary embodiment, the memory management circuit 51 can store the write data and the first parity data in the same physical unit, and store the second parity data in another physical unit. For instance, the memory management circuit 51 can first store the write data and the first parity data in the same physical unit, and temporarily store the second parity data in the buffer memory 55, and then store the second parity data in another physical unit in the rewritable non-volatile memory module 43 in a subsequent operation.

Subsequently, when reading the write data from the rewritable non-volatile memory module 43, the memory management circuit 51 can also read the first parity data (and the second parity data) from the rewritable non-volatile memory module 43. The decoding circuit 542 can perform the decoding operation according to the first parity data (and the second parity data) and the write data read from the rewritable non-volatile memory module 43 to detect and correct errors in the write data.

It should be noted that when reading the write data from the rewritable non-volatile memory module 43, the memory management circuit 51 can simply read the first parity data initially, and on the condition where a relatively high error correction capability is needed (i.e., in response to the failure to decode the first parity data), the second parity data can be read to increase the decoding speed.

In an exemplary embodiment, the memory management circuit 51 can initially simply read the write data and the first parity data from the rewritable non-volatile memory module 43. The decoding circuit 542 can perform the decoding operation according to the first parity data and the write data. If the decoding fails, the memory management circuit 51 can then read the second parity data from the rewritable non-volatile memory module 43, allowing the decoding circuit 542 to perform the decoding operation again according to the first parity data, the second parity data, and the write data. It should be noted that the parity data with a relatively long data length has a relatively high error correction capability. The decoding circuit 542 can combine the first parity data and the second parity data into the parity data with an even longer data length and perform the decoding operation according to the parity data with the longer data length and the write data to improve the decoding success rate.

It is worth mentioning that when reading the write data from the rewritable non-volatile memory module 43, the memory management circuit 51 can also read both the first parity data and the second parity data, thus allowing the decoding circuit 542 to perform the decoding operation according to the first parity data and the second parity data to improve the decoding success rate.

In an exemplary embodiment, the memory management circuit 51 can read the write data, the first parity data, and the second parity data from the rewritable non-volatile memory module 43. The decoding circuit 542 can combine the first parity data and the second parity data into the parity data with a longer data length (i.e., the parity data with the higher error correction capability), and perform the decoding operation according to the parity data with the longer data length and the write data to improve the decoding success rate.

In an exemplary embodiment, the encoding operation can further include a third encoding operation. In addition to the first encoding circuit and the second encoding circuit described above, the encoding circuit 541 can further include a third encoding circuit (not shown). During the process of the first encoding operation and the second encoding operation described above, the third encoding circuit in the encoding circuit 541 can perform the third encoding operation according to the write data to generate third parity data. In other words, the first encoding operation, the second encoding operation, and the third encoding operation can be performed simultaneously to reduce the delay caused by the encoding operation. The second parity data is not generated according to the first parity data. The third parity data is not generated according to the first parity data and the second parity data. In an exemplary embodiment, the third parity data is different from the first parity data and the second parity data. Besides, the first parity data alone, along with the second parity data, or along with the second parity and the third parity data, can be used to perform the decoding operation with the write data. The second parity data needs to be used along with the first parity data to perform the decoding operation with the write data. The third parity data needs to be used along with the first parity data and the second parity data to perform the decoding operation with the write data. In other words, the second parity data and the third parity data cannot be used alone to perform the decoding operation with the write data.

After encoding the write data, the memory management circuit 51 can send a write command sequence (also referred to as a second write command sequence) to the rewritable non-volatile memory module 43. The second write command sequence can be used to instruct the rewritable non-volatile memory module 43 to store the write data, the first parity data, the second parity data, and the third parity data. For instance, the memory management circuit 51 can first store the write data and the first parity data in the same physical unit, and store the second parity data and the third parity data in another physical unit in the rewritable non-volatile memory module 43. For instance, the second parity data and the third parity data can be stored in different physical units in the rewritable non-volatile memory module 43.

Subsequently, when reading the write data from the rewritable non-volatile memory module 43, the memory management circuit 51 can also read the first parity data (and the second parity data and the third parity data) from the rewritable non-volatile memory module 43. The decoding circuit 542 can perform the decoding operation according to the first parity data (and the second parity data and the third parity data) and the write data to detect and correct errors in the write data.

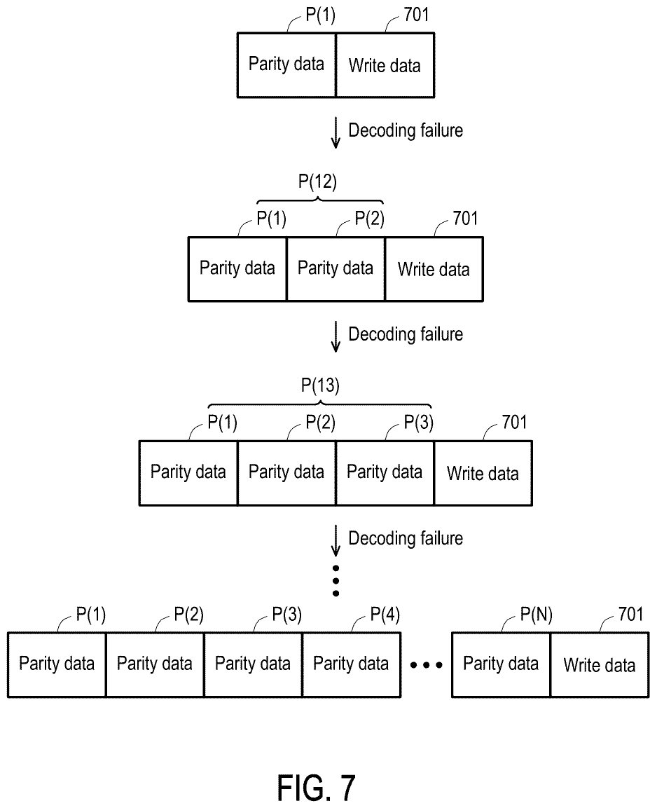

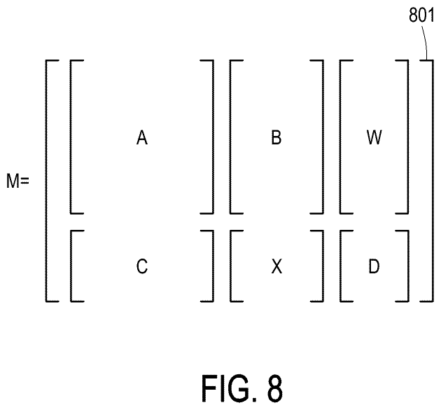

FIG. 7 is a schematic diagram of a decoding process according to an exemplary embodiment of the disclosure. Referring to FIG. 7, it is assumed that the first parity data P(1), the second parity data P(2), and third parity data P(3) are all generated by encoding the write data 701 stored in the rewritable non-volatile memory module 43. The related operation details have been described in detail above and will not be repeated here.

The memory management circuit 51 can read the write data 701 and the first parity data P(1) from the same physical unit in the rewritable non-volatile memory module 43. The decoding circuit 542 can use the first parity data P(1) and the write data 701 to perform the decoding operation. If the write data 701 and the first parity data P(1) can be successfully decoded (e.g., correcting all errors in the read write data 701), the decoding of the write data 701 can be completed.

On the other hand, if the write data 701 and the first parity data P(1) cannot be successfully decoded (e.g., not all errors in the read write data 701 can be corrected), the memory management circuit 51 can read the second parity data P(2) from another physical unit in the rewritable non-volatile memory module 43. The decoding circuit 542 can use the first parity data P(1), the second parity data P(2), and the write data 701 to perform the decoding operation. For instance, the decoding circuit 542 can combine the first parity data P(1) and the second parity data P(2) into parity data P(12) with a relatively long data length and a relatively high error correction capability, and perform the decoding operation according to the parity data P(12) and the write data 701 to improve the decoding success rate.

However, if the write data 701 and the parity data P(12) still cannot be successfully decoded, the memory management circuit 51 can further read the third parity data P(3) from another physical unit in the rewritable non-volatile memory module 43. The decoding circuit 542 can use the first parity data P(1), the second parity data P(2), the third parity data P(3), and the write data 701 to perform the decoding operation. For instance, the decoding circuit 542 can combine the first parity data P(1), the second parity data P(2), and the third parity data P(3) into parity data P(13) with a relatively long data length and a relatively high error correction capability, and perform the decoding operation according to the parity data P(13) and the write data 701 to improve the decoding success rate. In an exemplary embodiment, by gradually increasing the data length of the parity data during the decoding operation, the decoding circuit 542 can gradually improve the error correction capability for the write data 701.

In an exemplary embodiment, the encoding circuit 541 can perform multiple encoding operations on the same write data (e.g., the write data 701) to generate more parity data P(4) to P(N). Accordingly, when the write data 701 is decoded subsequently, in response to a decoding failure, more parity data P(4) to P(N) can be used to extend the parity data P(1), so as to effectively improve the decoding success rate for the write data 701.

In low-density parity check codes, a check matrix (also referred to as a parity check matrix) is configured to define an effective codeword. The parity check matrix is marked as a matrix M and a codeword is marked as V hereinafter. According to an equation (1) below, if a multiplication of the parity check matrix M and the codeword V results in a zero vector, it indicates that the codeword V is a valid codeword. Therein, an operator x represents a mod 2 matrix multiplication. In other words, a null space of the matrix M includes all the valid codewords. However, a content of the codeword V is not limited in the disclosure. For example, the codeword V may also include the error correcting code or the error detecting code generated by using any algorithm.

$$V \times {M}^{T} = 0 \qquad ( 1 )$$

The codeword V may include message bits and parity bits. Namely, the codeword V may be represented by [U P]. A vector U is constituted by the message bits. A vector P is constituted by the parity bits. The vector U is also referred to as write data (or data to be encoded). The vector P is also referred to as parity data.

In a codeword, parity bits (i.e., parity data) are configured to protect message bits (i.e., write data) and may be regarded as error correcting codes or error detecting codes generated corresponding to the message bits. In addition, protecting the message bits means, for example, maintaining the correctness of the message bits. For example, when a message bit is read from the rewritable non-volatile memory module 43, the parity bit corresponding to the message bit may be configured to correct possible errors in the message bit.

When decoding the codeword V, a parity check operation is first executed on the codeword V, such as multiplying the matrix M by the codeword V to generate a vector (hereinafter, marked as S, as shown in an equation (2) below). Each element in the vector S is also referred to as a syndrome. The vector S is also referred to as syndrome data. If the vector S is the zero vector (i.e., every element in the vector S is zero), the codeword V may be outputted directly. If the vector S is not the zero vector (i.e., at least one element in the vector S is not zero), it indicates the codeword V includes at least one error and the codeword V is not the valid codeword. If the codeword V is not the valid codeword, the error detecting and correcting circuit 54 may perform a decoding operation to attempt correcting errors in the codeword V.

$$V \times {M}^{T} = S \qquad ( 2 )$$

In an exemplary embodiment, the memory management circuit 51 can obtain the write data from the host system 11. At the same time point, the encoding circuit 541 can perform an encoding operation (also referred to as the first encoding operation) according to the write data and a plurality of sub-matrices (also referred to as the first sub-matrix and the second sub-matrix) in the matrix M to generate parity data (also referred to as the first parity data), and perform another encoding operation (also referred to as the second encoding operation) according to the write data and the sub-matrices (also referred to as the third sub-matrix and the fourth sub-matrix) in the matrix M to generate parity data (also referred to as the second parity data). That is, the first encoding operation and the second encoding operation are simultaneously performed. The first parity data is different from the second parity data. Besides, the first parity data can be used alone or along with the second parity data to perform a decoding operation with the write data. The second parity data cannot be used alone to perform the decoding operation with the write data.

After encoding the write data, the memory management circuit 51 may send a write command sequence (also referred to as a first write command sequence) to the rewritable non-volatile memory module 43. The first write command sequence may be configured to instruct the rewritable non-volatile memory module 43 to store the write data, the first parity data, and the second parity data in the rewritable non-volatile memory module 43. Subsequently, when reading the write data from the rewritable non-volatile memory module 43, the memory management circuit 51 may also read the first parity data (and the second parity data) from the rewritable non-volatile memory module 43. The decoding circuit 542 can perform the decoding operation according to the first parity data (and the second parity data) and the write data read from the rewritable non-volatile memory module 43 to detect and correct error in the data.

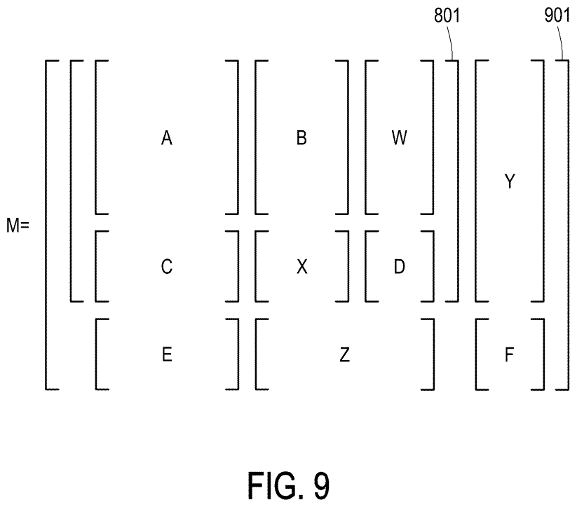

FIG. 8 is a schematic diagram of a parity check matrix according to an exemplary embodiment of the disclosure. Referring to FIG. 8, in an exemplary embodiment, the structure of the parity check matrix M is shown as a matrix 801. The matrix 801 includes a sub-matrix A, a sub-matrix B, a sub-matrix C, a sub-matrix D, a sub-matrix W, and a sub-matrix X. The sub-matrices W and X are zero matrices, and the sub-matrices A to D are non-zero matrices. The sub-matrix A can be an m×k matrix. The sub-matrix B can be an m×m matrix. The sub-matrix C can be an x×k matrix. The sub-matrix D can be an x×x matrix. The sub-matrix W can be an m×x matrix. The sub-matrix X can be an x×m matrix. Here, k, m, and x are all positive integers, k can be greater than m, and m can be greater than x. The arrangement of the sub-matrices A to D and the sub-matrices W and X in the matrix 801 is as shown in FIG. 8, which should however not be construed as a limitation in the disclosure.

In an exemplary embodiment, the first parity data can be generated according to an equation (3) provided below. In the equation (3), P(1) represents the first parity data, U represents the write data to be encoded, and A and B respectively represent the sub-matrix A and the sub-matrix B in the matrix 801. The equation (3) can be further decomposed into the equations (3.1) and (3.2) provided below. In the equations (3.1) and (3.2), Q(1) represents the transient data (also referred to as the first transient data) used in the process of generating the first parity data.

$$P ( 1 ) = {( {B}^{T} )}^{- 1} \times ( {A}^{T} \times U ) \qquad ( 3 )$$

$$Q ( 1 ) = {A}^{T} \times U \qquad ( 3.1 )$$

$$P ( 1 ) = {( {B}^{T} )}^{- 1} \times Q ( 1 ) \qquad ( 3.2 )$$

In an exemplary embodiment, the second parity data can be generated according to an equation (4) provided below. In the equation (4), P(2) represents the second parity data, U represents the write data to be encoded, and C and D respectively represent the sub-matrix C and the sub-matrix D in the matrix 801. The equation (4) can be further decomposed into equations (4.1) and (4.2) provided below. In the equations (4.1) and (4.2), Q(2) represents the transient data (also referred to as the second transient data) used in the process of generating the second parity data.

$$P ( 2 ) = {( {D}^{T} )}^{- 1} \times ( {C}^{T} \times U ) \qquad ( 4 )$$

$$Q ( 2 ) = {C}^{T} \times U \qquad ( 4.1 )$$

$$P ( 2 ) = {( {D}^{T} )}^{- 1} \times Q ( 2 ) \qquad ( 4.2 )$$

In an exemplary embodiment, the encoding circuit 541 can perform an encoding operation (also referred to as the first encoding operation) according to the write data U and the sub-matrix A (also referred to as the first sub-matrix) and the sub-matrix B (also referred to as the second sub-matrix) to generate the parity data P(1) (also referred to as the first parity data). In the first encoding operation, the encoding circuit 541 can perform matrix computation corresponding to the equation (3.1) according to the write data U and the sub-matrix A to generate the transient data Q(1), and then perform matrix computation corresponding to the equation (3.2) according to the transient data Q(1) and the sub-matrix B (i.e., an inverse matrix of the sub-matrix B) to generate the parity data P(1).

In an exemplary embodiment, the encoding circuit 541 can perform an encoding operation (also referred to as the second encoding operation) according to the write data U and the sub-matrix C (also referred to as the third sub-matrix) and the sub-matrix D (also referred to as the fourth sub-matrix) to generate the parity data P(2) (also referred to as the second parity data). In the second encoding operation, the encoding circuit 541 can perform matrix computation corresponding to the equation (4.1) according to the write data U and the sub-matrix C to generate the transient data Q(2), and then perform matrix computation corresponding to the equation (4.2) according to the transient data Q(2) and the sub-matrix D (i.e., an inverse matrix of the sub-matrix D) to generate the parity data P(2).

It should be noted that the encoding circuit 541 can, for instance, have a first encoding circuit (not shown) and a second encoding circuit (not shown) that operate independently of each other. At the same time point, the first encoding circuit can be used to perform the first encoding operation, and the second encoding circuit can be used to perform the second encoding operation. The encoding circuit 541 can perform the first encoding operation and the second encoding operation simultaneously to improve the encoding speed.

In the above exemplary embodiment, it is worth mentioning that the sub-matrix X in the matrix 801 is a zero matrix, and the encoding circuit 541 can generate the parity data P(1) and the parity data P(2) simultaneously (i.e., the parity data P(2) is not generated according to the parity data P(1)).

After encoding the write data, the memory management circuit 51 can send a write command sequence (also referred to as the first write command sequence) to the rewritable non-volatile memory module 43 to store the write data U, the first parity data P(1), and the second parity data P(2) in the rewritable non-volatile memory module 43. For instance, the memory management circuit 51 can store the write data U and the first parity data P(1) in the same physical unit of the rewritable non-volatile memory module 43, and store the second parity data P(2) in another physical unit of the rewritable non-volatile memory module 43.

Subsequently, when reading the write data U from one physical unit in the rewritable non-volatile memory module 43, the memory management circuit 51 can also read the first parity data P(1), and in response to a decoding failure, read the second parity data P(2) from another physical unit in the rewritable non-volatile memory module 43. Accordingly, the decoding circuit 542 can perform a decoding operation according to the first parity data P(1), the second parity data P(2), and the write data U to detect and correct errors in the write data. For details regarding the implementation of the decoding operation, please refer to the exemplary embodiment in FIG. 7, which will not be repeated hereinafter.

FIG. 9 is a schematic diagram of a parity check matrix according to an exemplary embodiment of the disclosure. Referring to FIG. 9, in an exemplary embodiment, the structure of the parity check matrix M is shown as a matrix 901. The matrix 901 includes the matrix 801 from FIG. 8, a sub-matrix E, a sub-matrix F, a sub-matrix Y, and a sub-matrix Z. The sub-matrix Y and the sub-matrix Z are zero matrices, while the sub-matrix E and the sub-matrix F are non-zero matrices. The sub-matrix E can be a y×k matrix. The sub-matrix F can be a y×y matrix. The sub-matrix Y can be an (m+x)×y matrix. The sub-matrix Z can be a y×(m+x) matrix. Here, k, m, x, and y are all positive integers, k can be greater than m, and m can be greater than x and y. The arrangement of the matrix 801 and the sub-matrices E to F and Y to Z in the matrix 901 is shown in FIG. 9, which should not be construed as a limitation in the disclosure. In an exemplary embodiment, the matrix 901 can be obtained by expanding the matrix 801 (adding the sub-matrices E to F and Y to Z).

In an exemplary embodiment, the third parity data can be generated according to an equation (5) provided below. In the equation (5), E and F respectively represent the sub-matrix E and the sub-matrix F in the matrix 901, and P(3) represents the third parity data. The equation (5) can be further decomposed into equations (5.1) and (5.2) provided below. In the equations (5.1) and (5.2), Q(3) represents the transient data (also referred to as the third transient data) used in the process of generating the third parity data.

$$P ( 3 ) = {( {F}^{T} )}^{- 1} \times ( {E}^{T} \times U ) \qquad ( 5 )$$

$$Q ( 3 ) = {E}^{T} \times U \qquad ( 5.1 )$$

$$P ( 3 ) = {( {F}^{T} )}^{- 1} \times Q ( 3 ) \qquad ( 5.2 )$$

In an exemplary embodiment, the encoding circuit 541 can perform an encoding operation (also referred to as the third encoding operation) to generate the parity data P(3) (also referred to as the third parity data) according to the write data U, the sub-matrix E (also referred to as the fifth sub-matrix), and the sub-matrix F (also referred to as the sixth sub-matrix). In the third encoding operation, the encoding circuit 541 can perform matrix computation corresponding to the equation (5.1) according to the write data U and the sub-matrix E to generate the transient data Q(3), and then perform matrix computation corresponding to the equation (5.2) according to the transient data Q(3) and the sub-matrix F (i.e., an inverse matrix of the sub-matrix F) to generate the parity data P(3).

It should be noted that the encoding circuit 541 can, for instance, have a first encoding circuit, a second encoding circuit, and/or a third encoding circuit (not shown) that operate independently of each other. In an exemplary embodiment, the sub-matrix X can be a zero matrix, and the parity data P(2) is not generated according to the parity data P(1). At the same time point, the first encoding circuit, the second encoding circuit, and the third encoding circuit in the encoding circuit 541 can perform the first encoding operation, the second encoding operation, and the third encoding operation respectively to generate the parity data P(1) to P(3), which can effectively improve the encoding speed.

After encoding the write data, the memory management circuit 51 can send a write command sequence to the rewritable non-volatile memory module 43 to store the write data U, the first parity data P(1), the second parity data P(2), and the third parity data P(3) in the rewritable non-volatile memory module 43. For instance, the memory management circuit 51 can store the write data U and the first parity data P(1) in the same physical unit of the rewritable non-volatile memory module 43, and store the second parity data P(2) and the third parity data P(3) in another physical unit of the rewritable non-volatile memory module 43. For instance, the second parity data P(2) and the third parity data P(3) can be stored in different physical units of the rewritable non-volatile memory module 43.

Subsequently, when reading the write data U from one physical unit in the rewritable non-volatile memory module 43, the memory management circuit 51 can also read the first parity data P(1), in response to a decoding failure, read the second parity data P(2) from the rewritable non-volatile memory module 43, and in response to another decoding failure, read the third parity data P(3) from the rewritable non-volatile memory module 43. For details regarding the implementation of the decoding operation, please refer to the exemplary embodiment in FIG. 7, which will not be repeated hereinafter.

It is worth mentioning that the first parity data P(1) can be used alone, along with the second parity data P(2), or along with both the second parity data P(2) and the third parity data P(3) to perform the decoding operation with the write data U. The second parity data P(2) needs to be used along with the first parity data P(1) to perform the decoding operation with the write data U. The third parity data P(3) needs to be used along with the first parity data P(1), the second parity data P(2), and the write data U to perform the decoding operation. By expanding the matrix M (e.g., by adding more sub-matrices to the matrix M), the encoding circuit 541 can encode the same write data according to the expanded matrix M to generate more parity data. Accordingly, when the write data is decoded subsequently, in response to a decoding failure, more parity data can be used sequentially to improve the decoding success rate of the write data.

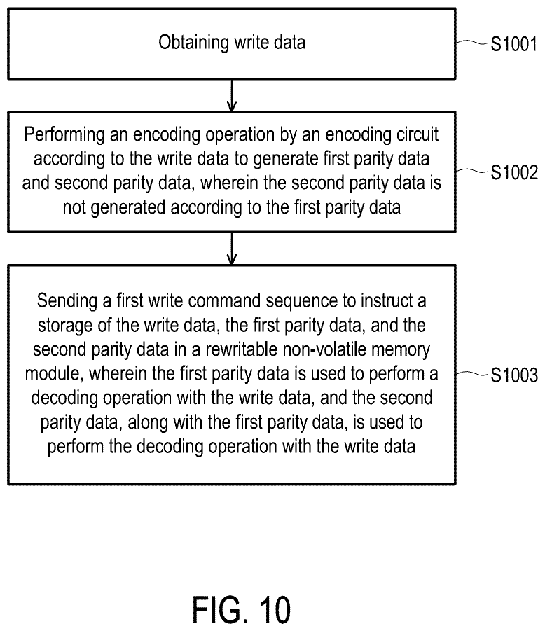

FIG. 10 is a flowchart of an encoding control method according to an exemplary embodiment of the disclosure. Referring to FIG. 10, in step S1001, write data is obtained. In step S1002, the encoding circuit performs an encoding operation according to the write data to generate first parity data and second parity data, wherein the second parity data is not generated according to the first parity data. In step S1003, a first write command sequence is sent to instruct a storage of the write data, the first parity data, and the second parity data in the rewritable non-volatile memory module, wherein the first parity data is used to perform a decoding operation with the write data, and the second parity data, along with the first parity data, is used to perform the decoding operation with the write data.

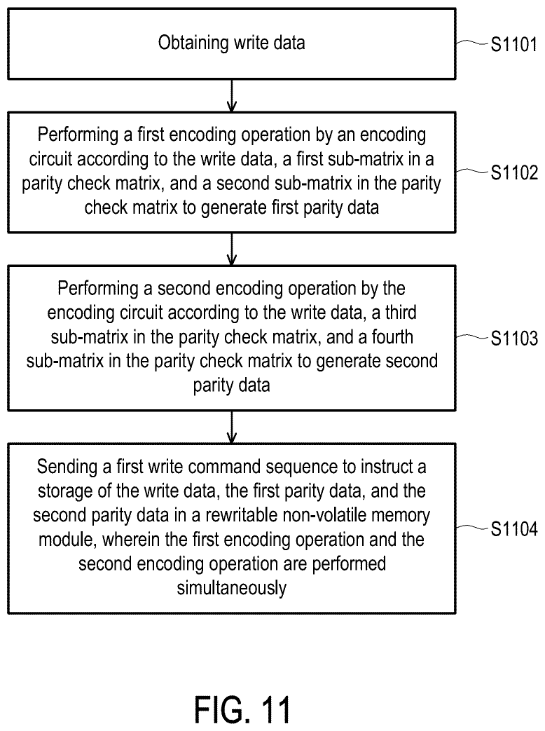

FIG. 11 is a flowchart of an encoding control method according to an exemplary embodiment of the disclosure. Referring to FIG. 11, in step S1101, write data is obtained. In step S1102, the encoding circuit performs a first encoding operation according to the write data, a first sub-matrix in a parity check matrix, and a second sub-matrix in the parity check matrix to generate first parity data. In step S1103, the encoding circuit performs a second encoding operation according to the write data, a third sub-matrix in the parity check matrix, and a fourth sub-matrix in the parity check matrix to generate second parity data. In step S1104, a first write command sequence is sent to instruct a storage of the write data, the first parity data, and the second parity data in the rewritable non-volatile memory module, wherein the first encoding operation and the second encoding operation are performed simultaneously.

However, the steps in FIG. 10 and FIG. 11 have been elaborated in the previous paragraphs and thus will not be repeatedly explained hereinafter. It is worth noting that the steps in FIG. 10 and FIG. 11 can be implemented as a plurality of codes or circuits, which should not be construed as a limitation in the disclosure. Moreover, the methods depicted in FIG. 10 and FIG. 11 can be used according to the above exemplary embodiments or used independently, which should not be construed as a limitation in the disclosure.

To sum up, one or more exemplary embodiments of the disclosure provide the step of encoding the same write data at the same time point to generate multiple corresponding parity data. Subsequently, the multiple parity data can be used individually or in combination depending on the decoding conditions and used to perform the decoding operation with the write data. As such, the encoding and decoding efficiency for the write data can be effectively improved, and the error correction capability can be enhanced.

The previously described exemplary embodiments of the present invention have the advantages aforementioned, wherein the advantages aforementioned not required in all versions of the present invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An encoding control method for a rewritable non-volatile memory module, the encoding control method comprising:
obtaining write data;
performing an encoding operation by an encoding circuit according to the write data to generate first parity data and second parity data, wherein the second parity data is not generated according to the first parity data; and
sending a first write command sequence to instruct a storage of the write data, the first parity data, and the second parity data in the rewritable non-volatile memory module,
wherein the first parity data is used to perform a decoding operation with the write data, and the second parity data, along with the first parity data, is used to perform the decoding operation with the write data.

2. The encoding control method according to claim 1, wherein the encoding operation comprises a first encoding operation and a second encoding operation, wherein the step of performing the encoding operation by the encoding circuit according to the write data to generate the first parity data and the second parity data comprises:
performing the first encoding operation by a first encoding circuit in the encoding circuit according to the write data to generate the first parity data; and
performing the second encoding operation by a second encoding circuit in the encoding circuit according to the write data to generate the second parity data,
wherein the first encoding operation and the second encoding operation are performed simultaneously.

3. The encoding control method according to claim 2, further comprising:
performing a third encoding operation by a third encoding circuit in the encoding circuit according to the write data to generate third parity data, wherein the third parity data is not generated according to the first parity data and the second parity data; and
sending a second write command sequence to instruct a storage of the third parity data in the rewritable non-volatile memory module,
wherein the third parity data, along with the first parity data and the second parity data, is used to perform the decoding operation with the write data,
wherein the first encoding operation, the second encoding operation, and the third encoding operation are performed simultaneously.

4. An encoding control method for a rewritable non-volatile memory module, the encoding control method comprising:
obtaining write data;
performing a first encoding operation by an encoding circuit according to the write data, a first sub-matrix in a parity check matrix, and a second sub-matrix in the parity check matrix to generate first parity data;
performing a second encoding operation by the encoding circuit according to the write data, a third sub-matrix in the parity check matrix, and a fourth sub-matrix in the parity check matrix to generate second parity data; and
sending a first write command sequence to instruct a storage of the write data, the first parity data, and the second parity data in the rewritable non-volatile memory module,
wherein the first encoding operation and the second encoding operation are performed simultaneously.

5. The encoding control method according to claim 4, wherein the first encoding operation comprises:
generating first transient data by the encoding circuit according to the write data and the first sub-matrix; and
generating the first parity data by the encoding circuit according to the first transient data and the second sub-matrix.

6. The encoding control method according to claim 4, wherein the second encoding operation comprises:
generating second transient data by the encoding circuit according to the write data and the third sub-matrix; and
generating the second parity data by the encoding circuit according to the second transient data and the fourth sub-matrix.

7. The encoding control method according to claim 4, further comprising:
performing a third encoding operation by the encoding circuit according to the write data, a fifth sub-matrix in the parity check matrix, and a sixth sub-matrix in the parity check matrix to generate third parity data; and
sending a second write command sequence to instruct a storage of the third parity data in the rewritable non-volatile memory module,
wherein the first encoding operation, the second encoding operation, and the third encoding operation are performed simultaneously.

8. The encoding control method according to claim 7, wherein the third encoding operation comprises:
generating third transient data by the encoding circuit according to the write data and the fifth sub-matrix; and
generating the third parity data by the encoding circuit according to the third transient data and the sixth sub-matrix.

9. A memory storage device, comprising:
a connection interface unit, configured to be coupled to a host system;
a rewritable non-volatile memory module; and
a memory control circuit unit, coupled to the connection interface unit and the rewritable non-volatile memory module,
wherein the memory control circuit unit is configured to:
obtain write data, and
send a first write command sequence to instruct a storage of the write data, first parity data, and second parity data in the rewritable non-volatile memory module,
wherein the memory control circuit unit comprises an encoding circuit, and the encoding circuit is configured to:
perform an encoding operation according to the write data to generate the first parity data and the second parity data, wherein the second parity data is not generated according to the first parity data,
wherein the first parity data is used to perform a decoding operation with the write data, and the second parity data, along with the first parity data, is used to perform the decoding operation with the write data.

10. The memory storage device according to claim 9, wherein the encoding circuit comprises a first encoding circuit and a second encoding circuit, and the encoding operation comprises a first encoding operation and a second encoding operation,
wherein the first encoding circuit performs the first encoding operation according to the write data to generate the first parity data, and
the second encoding circuit performs the second encoding operation according to the write data to generate the second parity data,
wherein the first encoding operation and the second encoding operation are performed simultaneously.

11. The memory storage device according to claim 10, wherein the encoding circuit comprises a third encoding circuit, and
the third encoding circuit performs a third encoding operation according to the write data to generate third parity data, wherein the third parity data is not generated according to the first parity data and the second parity data,
wherein the memory control circuit unit sends a second write command sequence to instruct a storage of the third parity data in the rewritable non-volatile memory module,
wherein the third parity data, along with the first parity data and the second parity data, is used to perform the decoding operation with the write data,
wherein the first encoding operation, the second encoding operation, and the third encoding operation are performed simultaneously.

12. A memory storage device, comprising:
a connection interface unit, configured to be coupled to a host system;
a rewritable non-volatile memory module; and
a memory control circuit unit, coupled to the connection interface unit and the rewritable non-volatile memory module,
wherein the memory control circuit unit is configured to:
obtain write data, and
send a first write command sequence to instruct a storage of the write data, first parity data, and second parity data in the rewritable non-volatile memory module,
wherein the memory control circuit unit comprises an encoding circuit, and the encoding circuit is configured to:
perform a first encoding operation according to the write data, a first sub-matrix in a parity check matrix, and a second sub-matrix in the parity check matrix to generate the first parity data, and
perform a second encoding operation according to the write data, a third sub-matrix in the parity check matrix, and a fourth sub-matrix in the parity check matrix to generate the second parity data, wherein the first encoding operation and the second encoding operation are performed simultaneously.

13. The memory storage device according to claim 12, wherein the encoding circuit comprises a first encoding circuit and a second encoding circuit.

14. The memory storage device according to claim 13, wherein in the first encoding operation, the first encoding circuit generates first transient data according to the write data and the first sub-matrix, and the first encoding circuit generates the first parity data according to the first transient data and the second sub-matrix.

15. The memory storage device according to claim 13, wherein in the second encoding operation, the second encoding circuit generates second transient data according to the write data and the third sub-matrix, and the second encoding circuit generates the second parity data according to the second transient data and the fourth sub-matrix.

16. The memory storage device according to claim 12, wherein the encoding circuit performs a third encoding operation according to the write data, a fifth sub-matrix in the parity check matrix, and a sixth sub-matrix in the parity check matrix to generate third parity data, and
the memory control circuit unit sends a second write command sequence to instruct a storage of the third parity data in the rewritable non-volatile memory module,
wherein the first encoding operation, the second encoding operation, and the third encoding operation are performed simultaneously.

17. The memory storage device according to claim 16, wherein the encoding circuit comprises a third encoding circuit, in the third encoding operation, the third encoding circuit generates third transient data according to the write data and the fifth sub-matrix, and the third encoding circuit generates the third parity data according to the third transient data and the sixth sub-matrix.

18. A memory control circuit unit, configured to control a rewritable non-volatile memory module and comprising:
a host interface, configured to be coupled to a host system;
a memory interface, configured to be coupled to the rewritable non-volatile memory module;
an encoding circuit; and
a memory management circuit, coupled to the host interface, the memory interface, and the encoding circuit,
wherein the memory management circuit is configured to:
obtain write data, and
send a first write command sequence to instruct a storage of the write data, first parity data, and second parity data in the rewritable non-volatile memory module,
wherein the encoding circuit is configured to:
perform an encoding operation according to the write data to generate the first parity data and the second parity data, wherein the second parity data is not generated according to the first parity data,
wherein the first parity data is used to perform a decoding operation with the write data, and the second parity data, along with the first parity data, is used to perform the decoding operation with the write data.

19. The memory control circuit unit according to claim 18, wherein the encoding circuit comprises a first encoding circuit and a second encoding circuit, and the encoding operation comprises a first encoding operation and a second encoding operation,
wherein the first encoding circuit performs the first encoding operation according to the write data to generate the first parity data,
wherein the second encoding circuit performs the second encoding operation according to the write data to generate the second parity data,
wherein the first encoding operation and the second encoding operation are performed simultaneously.

20. The memory control circuit unit according to claim 19, wherein the encoding circuit comprises a third encoding circuit,
and the third encoding circuit performs a third encoding operation according to the write data to generate third parity data, wherein the third parity data is not generated according to the first parity data and the second parity data,
wherein the memory management circuit sends a second write command sequence to instruct a storage of the third parity data in the rewritable non-volatile memory module,
wherein the third parity data, along with the first parity data and the second parity data, is used to perform the decoding operation with the write data,
wherein the first encoding operation, the second encoding operation, and the third encoding operation are performed simultaneously.

21. A memory control circuit unit, configured to control a rewritable non-volatile memory module and comprising:
a host interface, configured to be coupled to a host system;
a memory interface, configured to be coupled to the rewritable non-volatile memory module;
an encoding circuit; and
a memory management circuit, coupled to the host interface, the memory interface, and the encoding circuit,
wherein the memory management circuit is configured to:
obtain write data, and
send a first write command sequence to instruct a storage of the write data, first parity data, and second parity data in the rewritable non-volatile memory module,
wherein the encoding circuit is configured to:
perform a first encoding operation according to the write data, a first sub-matrix in a parity check matrix, and a second sub-matrix in the parity check matrix to generate the first parity data, and
perform a second encoding operation according to the write data, a third sub-matrix in the parity check matrix, and a fourth sub-matrix in the parity check matrix to generate the second parity data, wherein the first encoding operation and the second encoding operation are performed simultaneously.

22. The memory control circuit unit according to claim 21, wherein the encoding circuit comprises a first encoding circuit and a second encoding circuit.

23. The memory control circuit unit according to claim 22, wherein in the first encoding operation, the first encoding circuit generates first transient data according to the write data and the first sub-matrix, and the first encoding circuit generates the first parity data according to the first transient data and the second sub-matrix.

24. The memory control circuit unit according to claim 22, wherein in the second encoding operation, the second encoding circuit generates second transient data according to the write data and the third sub-matrix, and the second encoding circuit generates the second parity data according to the second transient data and the fourth sub-matrix.

25. The memory control circuit unit according to claim 21, wherein the encoding circuit performs a third encoding operation according to the write data, a fifth sub-matrix in the parity check matrix, and a sixth sub-matrix in the parity check matrix to generate third parity data, and
the memory management circuit sends a second write command sequence to instruct a storage of the third parity data in the rewritable non-volatile memory module,
wherein the first encoding operation, the second encoding operation, and the third encoding operation are performed simultaneously.

26. The memory control circuit unit according to claim 25, wherein the encoding circuit comprises a third encoding circuit, in the third encoding operation, the third encoding circuit generates third transient data according to the write data and the fifth sub-matrix, and the third encoding circuit generates the third parity data according to the third transient data and the sixth sub-matrix.
